(19) United States
(12) Patent Application Publication
(10) Pub. No.: US 2006/0022426 A1
(43) Pub. Date: Feb. 2, 2006

(54) Flat-faced detent for telescopic post locking in freight container

(76) Inventor: Martin Clive-Smith, Warwickshire (GB)

Correspondence Address: EDWARD S. WRIGHT, 1100 ALMA STREET, SUITE 207, MENLO PARK, CA, 94025, US

(21) Appl. No.: 11/145,512

(22) Filed: Jun. 3, 2005

(30) Foreign Application Priority Data
Jun. 3, 2004 (GB) 0412268.5

(51) Int. Cl. B62K 17/00

(52) U.S. Cl. 280/278

(57) ABSTRACT

Flat or flat-faced detents are insertable in corresponding flat sided apertures in container support posts to provide increased surface contact area and better load distribution.

### BACKGROUND OF THE INVENTION

1. Field of Invention

This invention relates to locking or latching—by so-called ‘detents’ of telescopic posts for freight containers.

Terminology

### Detent

The term ‘detent’ embraces diverse forms, but a feature is one or more (load)—e.g., multiple discrete or single continuous—contact bearing surfaces.

The nature, shape, contour or profile of an individual bearing surface admits of considerable variation and may be continuous or discontinuous.

A detent is typically part of a male-female locating or fastening contrivance.

A common container support post is configured as a telescopic strut, of mutually inter-fitting post elements, of generally rectangular cross-section, with a locking pin detent operative therebetween.

Pins are inserted in mutually aligned aperture creating through-holes in juxtaposed post elements.

This secures relative position and transfers (axial) stacking and suspension loads.

### Index Positions

Apertures are traditionally incrementally spaced for relative post adjustment in prescribed multiples.

Aperture alignment defines index positions in relative post element disposition.

Detent location and retention is by contact friction under transferred load.

That said, optional locking elements may be fitted.

Generally, detents sit—and are movable across or transversely of—post and relative post mobility axes.

Disposition & Orientation

Some aspects of the invention are concerned with aperture and detent disposition and orientation.

Temporary removal of a detent from a post movement path is required to allow relative post positional adjustment.

Detent re-instatement preserves a given relative post positioning—for load transfer therebetween.

### Racking

In addition to compression (stacking) and tension (lift) loads imposed longitudinally along a post or strut axis, transverse ‘racking’ loads across the post axis can arise upon handling and interaction with other stacked containers in transit.

### Transverse vs Longitudinal

Racking can arise across transversely (i.e., from side-to-side) or longitudinally (i.e., from end-to-end) of a container deck platform.

Transverse racking is generally more acute than longitudinal racking, particularly when multiple clustered corner end posts are employed, as with dual span (say 40 ft and 45 ft standard) platforms.

### Shear

Such racking loads put a post in shear—to withstand which local post cross-section and location of detent apertures are important considerations.

### Tension & Compression Faces

More specifically, for a rectangular post cross-section, opposed faces in the plane of racking are in shear and bounding opposed faces are respectively in compression and tension upon post bending tendency.

### Tolerance & Lozenging

Tolerance between slidably inter-fitting posts and between post location apertures and detents allows racking loads to create lozenging of container profile.

A snug interfit between location aperture and detent is thus desirable—consistent with ease of insertion and removal, along with considerations of corrosion and wear discussed later.

Detent apertures with local removal of wall material mean local post section weakening.

Thus detent aperture profile and disposition must take account of post loading—particularly in shear.

### Round Detent Pin

Traditionally round detent pins are used, for ease and low cost of production from standard round section bar stock.

A conventional (nominally) round(ed) pin detent form, generally of uniform or symmetrical circular section, is readily adopted from standard bar stock sizes or sections.

Alternatively, bespoke detent diameters are readily machined (e.g. turned down on a lathe) from bar stock.

Similarly, a round aperture is readily drilled.

Other profiles, such those with flat facets as envisaged in the present invention, require special machining—an on-cost consideration, but one offset by certain operational benefits later described.

### Localized Contact, Limited Bearing Surface, Localized Wear & Corrosion

For necessary working clearance, round aperture and pin sections afford limited bearing contact.

Generally, such contact is made at one or other side—according to whether bearing (downward) stacking or (upward) lifting loads.

### Load Distribution—Wear Susceptibility

A limited contact area offers minimal load distribution and so is susceptible to surface sliding contact friction wear, upon repeated pin insertion and removal and vibration in transit under load.

Repeated and reverse (un)loading create an elongated or oval wear form -with even greater slack or play admitted between unloaded post elements.

Limited contact means susceptibility to localized wear, corrosion at contact surfaces and seizure.

### Corrosion

Moreover, surfaces in even limited contact, upon exposure to atmospheric moisture and even salt spray, such as during a sea voyage, over a prolonged period, are prone to corrosion and seizure in situ.

Severe shock impact loads are needed to loosen and free pins corroded in situ—and which may damage, distort and buckle a pin profile, impeding ongoing (re-)insertion and removal.

That in itself creates wear and an irregular scuffed surface profile, with even greater vulnerability to corrosion—and so the undesirable cycle repeats.

2. Related Art

### Adjustable Post Span

Variable container support post height or span is known.

Such variability can be achieved by adjusting, re-locating, or even substituting altogether, certain key structural elements, such as elongate (support) struts, posts or ties, which define or reflect the overall container dimensional span, in particular height or depth in relation to a base platform.

### Container Posts

Co-pending patent applications such as GB0029438.9, Australian No 47705/00, German No 10082697.0, U.S. Ser. No. 09/743777, and U.S. Ser. No. 10/726763 (based upon PCT WO98/09889—itself reflecting GB97/02319) envisage deck support post adjustability, in the context of deck position and orientation variability—for multiple independent deck module stacking.

### Detent

These applications also introduce flat-faced detents in general terms—but not in the developed forms now envisaged and set out herein.

Similarly, GB1505657 envisages containers with telescopic legs, swung from stowage within a container profile, to a laterally-outboard stance, at which they are extended to lift and support a container clear of a carrier vehicle chassis.

### Adjustable Posts

A diverse mix of adjustable post structures has been proposed for varied applications, for example:

U.S. Pat. No. 4,492,170—vertically adjustable table post with u-shaped bent metal locking plate;

U.S. Pat. No. 3,850,395—instrument support structure with telescopic post element and pivoting base legs lockable by extendable struts per fluid actuators;

U.S. Pat. No. 6,554,235—telescopic support post with external longitudinal grooves for clamping engagement with accessory support brackets;

U.S. Pat. No. 4,896,992—adjustable mounting frame of profiled frame sections and connectors, with square detent protrusions for frame engagement;

GB2274773—telescopic table leg whose upper portion is secured to table top and received within hollow lower leg portion, with friction-fit plastic bushings and optional spring-loaded detent;

U.S. Pat. No. 5,307,598—post with adjustable mounting for post inclination relative to a ground stake;

U.S. Pat. No. 5,110,076—adjustable multiple support stand for medical fluids, with support poles individually adjustable to a desired height by spring-loaded trigger assemblies with locking pins.

However, none of this art recognizes or refines detent configuration issues.

### OBJECTS AND SUMMARY OF THE INVENTION

It is in general an object of the invention to provide a new and improved detent for locking telescopic posts as used, for example, in freight containers.

Another object of the invention is to provide a detent of the above character which overcomes the limitations and disadvantages of the prior art.

These and other objects are achieved in accordance with the invention by providing a detent assembly having two relatively movable elements with openings which are aligned with each other when the elements are in a predetermined position, and a detent body inserted into the aligned openings to hold the two elements in the predetermined position with a (continuous or discontinuous) flat face bearing surface of the body in load supporting engagement with one of the two elements over substantially the entire surface area of a flat abutment face along one edge of the opening in the element.

One aspect of the invention provides—in the context of a support post, such as upon a container platform base—a detent, or retention element, for (index) location of movable posts or struts, with a flat-faced profile portion, upon one or more abutment faces, for load bearing and/or sharing contact with corresponding post reception apertures.

### Flat-Faced Bearing Surface(s)

A prime bearing surface form according to the invention is a flat, or flat-faced, profile.

Flat applies to both localized detent surface profile and corresponding aperture profile.

A single continuous flat surface represents a simple detent form, but variants are envisaged.

Thus, segmented multiple juxtaposed flat surface portions or ‘lands’, separated by intervening transition profiles, such as grooves or recesses, could be employed.

Flats are contiguous in the sense that material continues in between, but in a recessed profile.

A serrated profile is a particular such discontinuous profile, with individual spaced flat lands or faces lying generally parallel to one another.

Overall ‘flat’ surface area is greater than over other (say pronounced curvature) profiles or forms—albeit, ‘nearly’ flat or shallow curvatures are not precluded.

Thus flat-faced, mutually interfitting male-female bearing surfaces characterizes detent action according to the invention.

### Container Format

A container format with telescopic posts and detents may be open or closed, box, platform or lattice.

Posts can be hinged for collapse fold upon a platform base—in a so-called ‘flat-rack’ configuration.

### Detent Path

Operationally, a detent movement path generally has component of movement transverse (e.g., orthogonal) to a post longitudinal axis.

This does not preclude ‘diagonal’ (i.e., a combination of longitudinal and transverse) disposition according to some aspects of the invention.

Post span reduction by telescopic fore-shortening and detent relocation can allow fold upon a base with mutually juxtaposed posts.

### Post Face Interaction

A detent interacts with a selected aperture set in an upright support post face.

For racking suppression, detent apertures are set in post faces aligned transversely of a deck platform.

Thus detent insertion and withdrawal is longitudinally of the platform.

Other detent considerations according to various aspects of the invention include:
a plate bearing surface area as a ‘large’ proportion of overall post cross-section;
post elements of mutually inter-fitting profile—e.g. telescopic;
‘slack’ fit—clearance opposite to loaded contact face;
oblique (for example, ‘diagonal’) movement—gravity (self location;
wedge action—in which an oblique/sloping/tapered face draws together corresponding post faces into abutment;
a segmented face or stepped face;
detent retention.

### Detent Retention

A detent security retention, entrainment or entrapment can be contrived with, say, a latch or lock, such as a removable cross-pin, itself captured by a fastener, such as a spring clip.

Thus, upon withdrawal from aligned detent apertures in juxtaposed inner and outer post faces, a detent can remain partially (say nose) inserted in, or held captive alongside, an outer post aperture.

That is, a single outer post detent aperture is aligned with a selected one of a succession of inner post apertures to achieve a set relative axial positioning of inner and outer posts.

### Detent Carrier

A detent can be fitted upon a support or ‘carrier’, with action and/or configuration characteristics including:
free (floating);
entrained (e.g. restraint chain), held captive; or
supported over range of (dis)engagement.
   Detent Movement Path

Generally, a detent guide(way) and/or carrier determines detent movement path or traverse and complements contact surface profile.

Arcuate

So, say, an arcuate movement path could be reflected in an arcuate detent bearing surface.

Common respective arc centers could be employed to minimize surface interaction—that is for smooth uninterrupted detent entry and withdrawal in relation to a correspondingly profiled detent aperture.

### Extremities

Limit extremities of detent movement may also be defined, if not the path between.

### Alignment

Detent alignment with a detent aperture at, or close to, an extremity of movement may also be ensured.

### Arcuate Detent Path—Profile

Thus, say, a swing arm detent carrier could suspend a detent about an upper pivot—allowing detent movement through an arc about the pivot.

A shallow (arcuate) face curvature detent profile could complement an arcuate carrier path.

### Arc Tangent

Alternatively, a detent (bearing surface - taper) contact path could represent a tangent to a carrier movement arc, at a fully inserted or installed detent position within a mounting aperture.

### Complex Pivot

A bespoke complex pivot, such as an elongate pivot pin hole or double pivot could be employed, to admit more linear detent movement.

### Operational Considerations

Further detent operational considerations include:
ease of insertion & removal;
inhibition of corrosion risk;
preservation of clearance/tolerant fit—notwithstanding load bearing face contact, so contact can be broken, by movement of surfaces away from one another.

### Mechanical (Dis)Advantage/Velocity Ratio

Some mechanical (dis-)advantage, leverage or (velocity ratio) gearing could be incorporated in detent carrier—and/or by interaction with a detent or between detent and detent aperture.

### Detent Re-Orientation

Detent re-orientation may be effected between removal and re-insertion, say to present a different depth span.

### Detent Cam Action

Similarly, detent re-orientation (say rotation) could drive detent aperture re-disposition—say in the manner of a lifting cam.

Such a rotational cam action could also effectively lock a detent within a detent aperture—or at least take up mutual interfit tolerance or slack.

Desirably, a detent is configured for manual insertion and/or removal.

### Power-Assisted Detent Action

That said, powered or power-assisted detent action might be contemplated—say with an external torque wrench or impact hammer.

Nevertheless, overall, minimal detent and detent carrier complexity for purpose are desirable.

### Interfit

In order to minimize relative movement and attendant noise (rattle) and profile lozenging or trapezoidal racking, a close interfit between pin and location aperture or hole is desirable.

Such racking attends static and dynamic post loading—with an axial stacking or lifting component and transverse shear or bending component.

In relation to a container (deck) platform, or rectangular cross-sectional planform, transverse (cross-deck) racking is more severe than longitudinal (along-deck) racking, which can be damped by deck coupling to multiple spaced support posts.

### Supplementary Statement(s) of Invention

According to one aspect of the invention, a detent, or retention element, for location between relatively movable posts, has a flat faced bearing contact profile, upon one or more abutment faces, for load bearing/sharing contact with corresponding post apertures.

### Taper—Wedge

A tapered detent profile may be adopted, for progressive wedge locking abutment action with a corresponding post aperture or hole profile.

In practice, a taper can represent or be expressed by diverse configurations, including:
an inclination, say acute angle, between a bearing or contact surface and a direction of mobility or freedom of movement; and/or
a progressively changing spacing or depth between opposed bearing surfaces, with either or both inclined to a movement direction.

Thus, say, a slim flat plate, of tapered planform and of either even or tapered depth, may be employed.

Taper is not restricted to flat surfaces, rather the relative spacing of curved surfaces can reduce.

### Adjustable Post

According to another aspect of the invention an adjustable span container support post, with relatively movable post elements is fitted with intervening ‘flat’ or flat-faced detents, such as flat plates, to preserve relative disposition of post elements.

Insertion of a detent effectively preserves or retains relative post element disposition.

A flat detent face can extend over a substantial proportion of an overall post cross-section—or at least significantly greater than a conventional round pin.

Detent apertures may also be tapered—say of progressively varying depth in a direction of detent relative movement—in order to complement detent profile taper.

### BRIEF DESCRIPTION OF THE DRAWINGS

There now follows a description of some particular embodiments of the invention, by way of example only, with reference to the accompanying diagrammatic and schematic drawings, in which:

FIG. 1 shows a perspective view of a telescopic support post, with juxtaposed flat-face detent pin;

FIGS. 2A and 2B show vertical sectional views of the support post of FIG. 1, with detent pin inserted, and attendant local contact enlargement, under stacking and lifting;

More specifically:

FIG. 2A shows detent pin insertion to transfer downward stacking post loading;

FIG. 2AA shows a local enlarged contact surface detail of FIG. 2A;

FIG. 2B shows a detent pin inserted to transfer upward stacking post loading;

FIG. 2BB shows a local enlarged contact surface detail of FIG. 2B;

FIG. 3 shows a perspective view of a telescopic support post, such as of FIG. 1, but with a tapered plate detent pin and complementary waisted profile post reception apertures;

FIGS. 4A, 4B and 4C show various transverse and vertical sections through the support post of FIG. 3, with detent pin disposition and local contact enlargement; more specifically:

FIG. 4A shows tapered (plan) detent pin introduction to mutually aligned reception apertures of corresponding tapered profile in inner and outer support post elements;

FIG. 4B shows a follow-on stage to FIG. 4A, with full tapered detent pin insertion, and (optional) end retention;

FIG. 4BB shows a local enlarged contact surface detail of FIG. 4B;

FIG. 4C shows a vertical section of a support post under downward stacking loading;

FIG. 4CC shows a local enlarged contact surface detail of FIG. 4C;

FIG. 5 shows a perspective view of a telescopic support post, such as of FIGS. 1 and 3, but with a variant detent pin with head location profile;

FIGS. 6A and 6B show vertical sections through the post of FIG. 5 with local contact enlargement; more specifically:

FIG. 6A shows initial detent pin insertion; and

FIG. 6B shows full detent pin insertion upon downward stacking loading;

FIG. 6BB shows local enlarged contact surface detail of the lower detent portion of FIG. 6B;

FIG. 6BBB shows local enlarged contact surface detail of the upper detent portion of FIG. 6B;

FIG. 7A shows a vertical post section with an enlarged head inclined detent; FIGS. 7B through 7L show variant detent pin and attendant location aperture configurations for the arrangement of FIG. 7A—with only local detail depicted for simplicity; more specifically:

FIG. 7A shows a vertical section through a telescopic support post with an enlarged head detent pin, under downward stacking loading;

FIG. 7B shows a vertical section through a telescopic support post with serrated detent pin profile, under downward stacking loading;

FIG. 7C shows a vertical section through a telescopic support post with stepped detent pin profile, under downward stacking loading;

FIG. 7D shows a vertical section through a telescopic support post with waisted detent pin profile, under downward stacking loading;

FIG. 7E shows a vertical section through a telescopic support post with dual coupled detent stems, under downward stacking loading;

FIG. 7F shows a vertical section through a telescopic support post with concave waisted detent pin profile, under downward stacking loading;

FIG. 7G shows a vertical section through a telescopic support post with cruciform detent pin profile, under downward stacking loading;

FIG. 7H shows a vertical section through a telescopic support post with bowed detent pin profile, under downward stacking loading;

FIG. 7J shows a vertical section through a telescopic support post with constrained detent pin profile, under downward stacking loading;

FIG. 7K shows a vertical section through a telescopic support post with sagging detent pin profile, under downward stacking loading;

FIG. 7L shows a vertical section through a telescopic support post with serrated detent pin upper profile and slidable insertion/removal platform, under downward stacking loading;

FIGS. 8A through 8R show diverse stand-alone detent profiles; more specifically:

FIG. 8A shows a single-sided plate taper form;

FIG. 8B shows a truncated pyramidal stub form;

FIG. 8C shows a double-sided, vertical plate taper form;

FIG. 8D shows a double-sided planform plate taper form;

FIG. 8E shows an angled plate form;

FIG. 8F shows a discrete angled twin plate form;

FIG. 8G shows an inverted ‘U’ or ‘C’ section plate form;

FIG. 8H shows a concave strip form;

FIG. 8J shows a stacked discrete plate form;

FIG. 8K shows a transverse paired discrete plate form;

FIG. 8L shows a multiple array or cluster of juxtaposed vertical taper plate forms;

FIG. 8M shows a bifurcated plate form;

FIG. 8N shows off-set detent apertures in a support post;

FIG. 8O shows a (mortice and tenon) slidable inter-fitting detent form;

FIG. 8P shows a vertical stack of double-sided planform tapered detents;

FIG. 8Q shows a rectangular profiled inter-connecting detent form;

FIG. 8R shows a dovetail inter-connecting detent form;

FIGS. 9A through 9C show a prior art round detent pin; more specifically,

FIG. 9A shows a conventional round pin in a round hole;

FIG. 9B shows an enlarged view of the surface contact area of FIG. 9A;

FIG. 9C shows a close-fitting pin in hole with intervening corrosion.

FIGS. 10A and 10B reflect a practical flat -rack container construction with paired extensible, cross-braced, end posts with flat-face detents according to the invention; more specifically:

FIG. 10A shows an end elevation with (corner) end post (inner post element) extension beyond cross-braced (outer) bottom post elements; and

FIG. 10B shows a side elevation with suspended upper deck and detent retention;

FIGS. 11A and 11C show flat face detent and detent aperture profiling, along with supplementary view aperture for inner and outer post element aperture alignment preparatory to detent insertion, for the container of FIGS. 10A and 10B; more specifically:

FIG. 11A shows local interaction of a flat-faced detent with detent apertures in upper extensible (inner) and (base) outer post elements;

FIG. 11B shows an enlargement detail of FIG. 11A;

FIG. 11C shows variant detent profile options.

### DETAILED DESCRIPTION

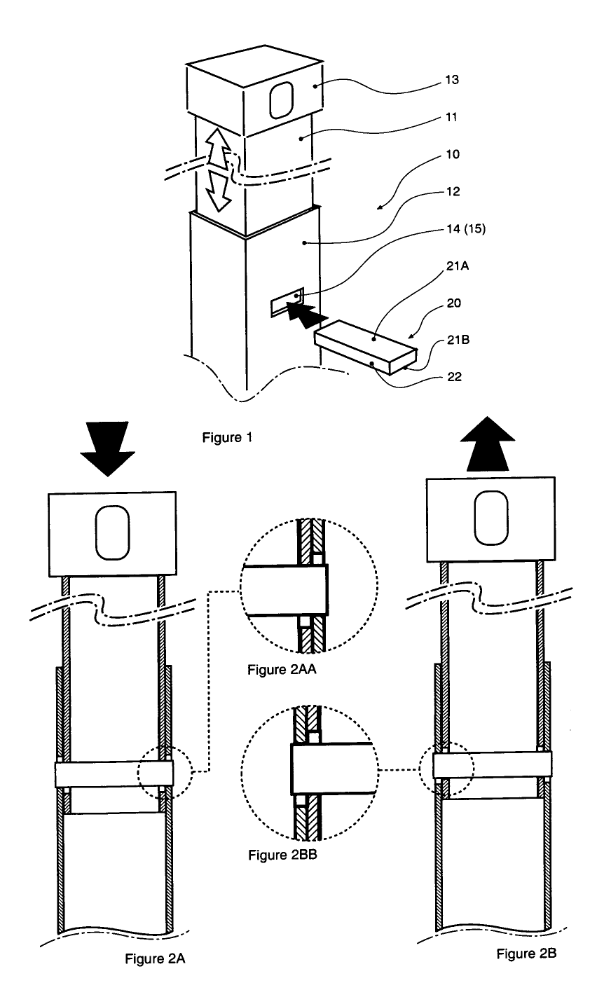

As reflected in FIG. 1, a detent for a telescopically adjustable container post has a flat face—as does a corresponding location aperture in a post face.

Detent load transfer bearing action and contact faces are reflected in FIGS. 2A through 2BB.

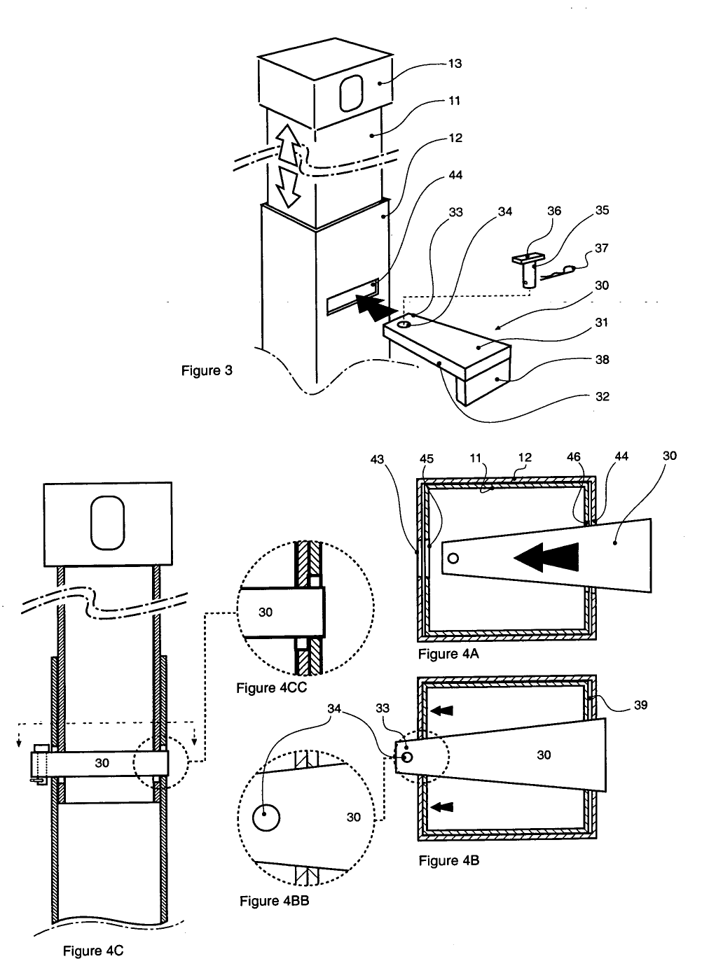

Beyond merely flat, diverse detent forms are explored to meet particular operational considerations in FIGS. 3 through 8R.

### Common Feature

This diversity should not distract from a fundamental common feature—that is flat or flatness in detent and aperture profile.

### Detent Profile

A detent is configured as a short stem or stub element, with at least one local flat-faced load surface contact area on one side—and desirably upon opposite sides, to accommodate reverse loading.

### Squat

Detent length or span is relatively ‘modest’—and detent breadth is relatively ‘generous’.

Such a ‘stubby’ or ‘squat’ profile is desirable in order to take stacking or lifting loads, without undue bending or distortion.

Detent depth is ‘generous’, with similar rationale.

Thus in FIGS. 1 and 2A/2B, a detent 20 is configured as a flat, even depth, plate, with opposite (horizontal) upper and lower bearing surfaces 21A, 21B between parallel upright side surfaces 22.

Detent 20 locates in both:
a complementary profile aperture or slot 14 in a lower (outer) post element 12 of a telescopic (container) support post 10; and
a corresponding aligned aperture 15 in an upper (inner) post element 11.

In practice, detent apertures are desirably disposed in post side faces aligned transversely of the container platform—to counter attendant greater susceptibility to racking.

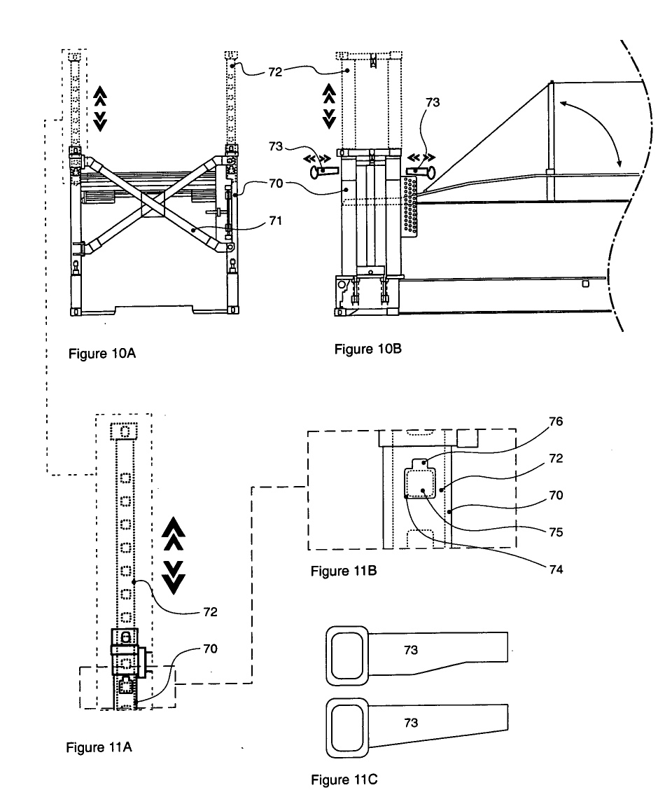

Longitudinal racking is inhibited by the paired end posts as evident in FIG. 10B.

### Rectangular—Tapered—Trapezoidal

Detent cross-section is desirably generally rectangular in (horizontal) plan, but trapezoidal and tapered forms can be contemplated.

Similarly, a rectangular (vertical) cross-section is desirable, but again trapezoidal and tapered forms can be contemplated.

FIG. 3 shows a tapered planform detent 30 of even depth, again with upright intervening sides 32 between opposite (upper and lower) flat faces 31, and with depending retention stub 38.

### Differential Location Apertures

With such a detent profile, differential span ‘entry’ and ‘exit’ (detent location) apertures are desirable.

FIG. 4A shows juxtaposed wide, but progressively reduced, span entry apertures 44, 46 and exit apertures 43, 45 in outer and inner post sections 12, 11 respectively.

FIG. 4B shows taper wedge detent 30 fully occupying aligned aperture pairs, 43, 45 and 44, 46.

A detent nose apex 33 emerges from the opposite side of posts 11,12 to that of entry.

This exposes a capture aperture 34 for a lock pin 35, itself with a bored stem to receive a locking clip 37.

Lock pin 35 is fully inserted until a head 36 sits upon detent face 31—whereupon stem bore emerges from the detent 30 to receive clip 37.

Detent 30 profile and corresponding apertures 43, 44, 45, 46 are configured for wedge locking abutment action upon detent 30 insertion.

Thus, inner post 11 exit aperture 45, is restricted to minimal width to allow detent nose 33, to emerge from outer post 12 to receive lock pin 35.

In practice, this means through-passage of detent 30 is restricted within inner post 11 when detent nose 33 has just passed through exit aperture 45.

Thus, further insertion of detent 30, through entry apertures 44 and 46, forces inner post 11 to move with detent 30 until it abuts with outer post 12 at the exit side.

Lock pin 35, and in particular head 36, is configured to retain nose 33 in a position which maintains the abutment of inner and outer posts 11, 12.

Lateral working clearance, tolerance or slack 39 (shown exaggerated for clarity) between posts 11, 12 appears to the trailing side of wedge 30.

According to transverse or horizontal taper profile, clearance between the other sides could be shared evenly between posts 11, 12—or offset to one side.

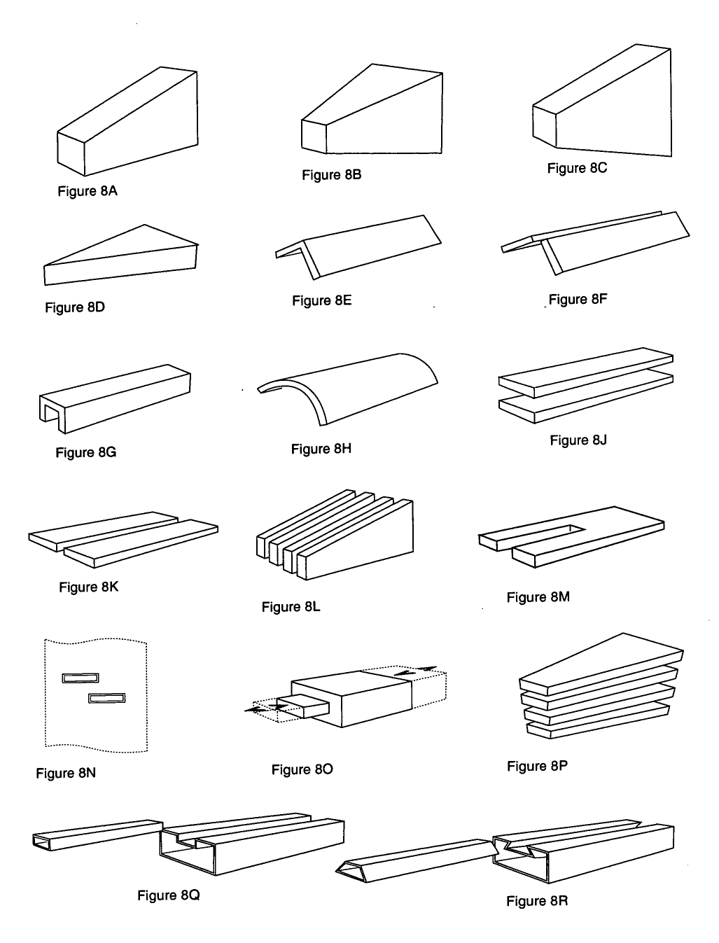

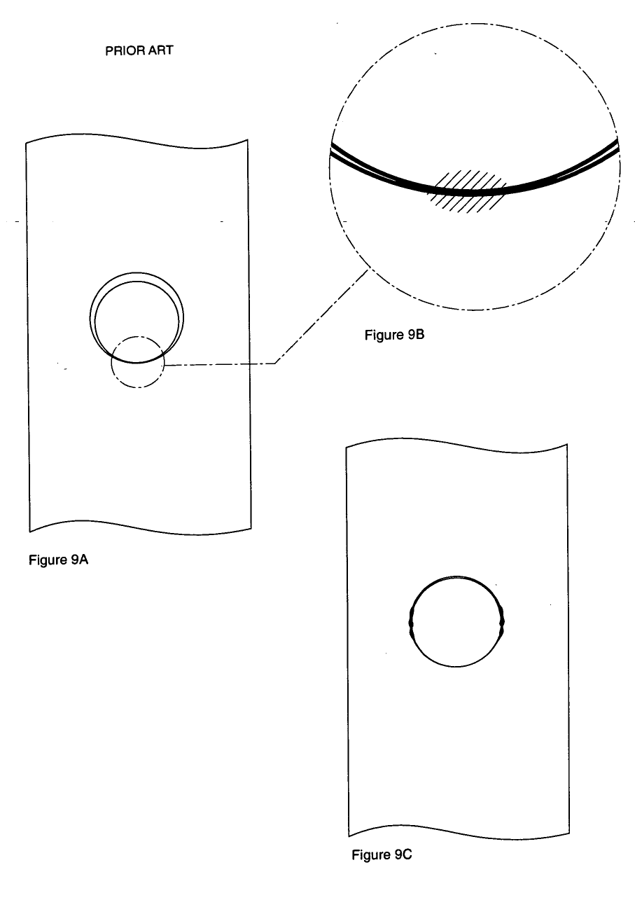

With a vertical, upright or longitudinal (in relation to post axis) detent taper, such as in FIG. 8A, vertical clearances between detent and reception aperture could be (re-)distributed, or taken up altogether.

FIG. 4BB enlargement detail of FIG. 4B shows snug interfit of detent 30 and exit apertures 43, 45.

FIG. 4CC enlargement detail of FIG. 4C shows vertically offset clearances between detent 30 and entry apertures 44, 46.

This reflects imposition of stacking load through a capture fitting 13 upon upper inner post 11, and transfer as shear across detent 30 to outer post 12.

### Truncated Pyramid

A combination of horizontal and vertical taper, or truncated (absent or minimal apex) pyramidal form, would provide a dual wedge locating action between telescopic post sections.

### Detent Profile Variants

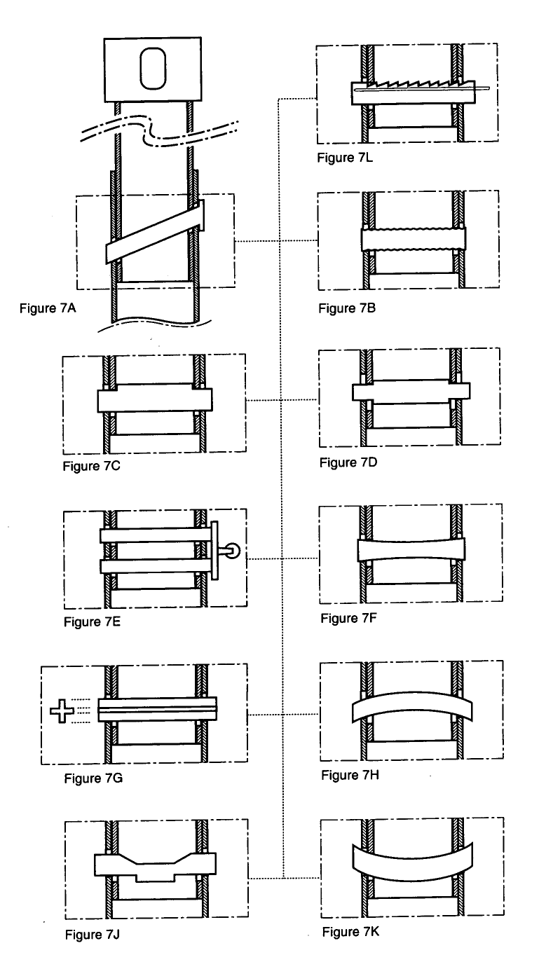

FIGS. 7A through 7L and 8A through 8R explore variant detent profile—and are generally self-explanatory, so will not be described in detail.

Similar considerations apply to interaction between detent and reception apertures in support posts.

### Inclined Detent

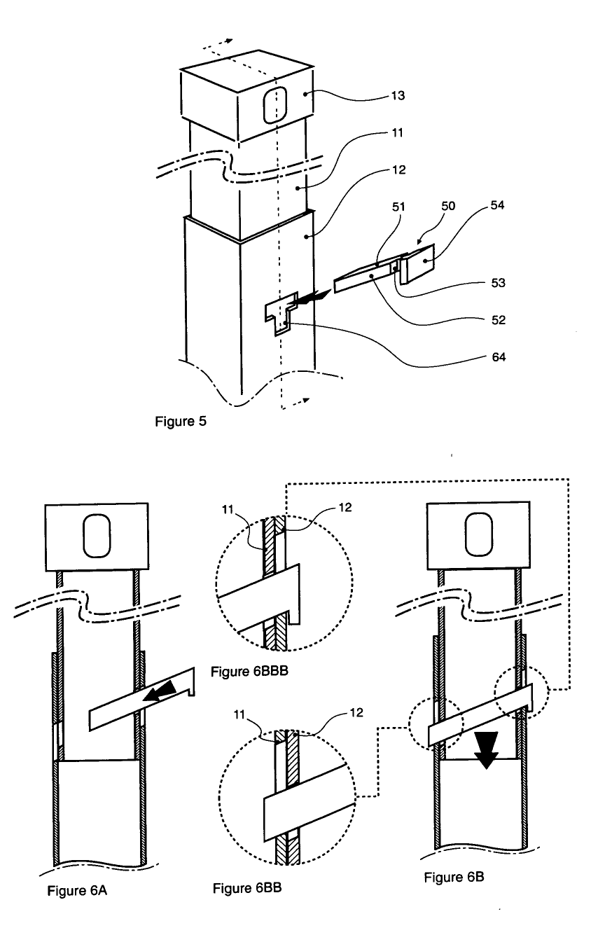

FIG. 5 depicts an inclined detent 50 orientation and disposition in relation to post axis.

In this case the detent 50 is otherwise generally a flat plate with opposed upper and lower bearing surfaces 51 and orthogonal side edges 52.

A somewhat enlarged locating head 54 prefaced by a narrower neck recess or slot 53 terminates the outboard end of the plate stem, for location in a complementary ‘T’ profile slot 64 in posts 11, 12.

FIG. 6B shows secure detent 50 location, with head 54 somewhat overlapping the outer post 12.

FIG. 6BB local enlargement detail of FIG. 6B reflects relative inner and outer post 11, 12 displacement upon downward stacking load.

Similarly, with FIG. 6BBB local enlargement detail of FIG. 6B, but for the upper detent portion.

### Split Wedge

An expandible, e.g. bifurcated or split, expandible wedge configuration (not shown) could take-up slack, working clearance or tolerance between detent and aperture.

This would also promote relative lateral movement between telescopic post sections—again to take up operating clearance or tolerance therebetween.

Similarly, inclined, waisted or chamfered longitudinal side edge profiles 22, 32, 52 can be employed—effectively giving additional bearing surface.

### Re-Entrant

A multiple re-entrant—say stepped or serrated dovetail—vertical sectional profile could embody vertically and horizontally staggered, mutually overlapping, bearing surfaces.

Again, such a configuration would increase the overall (collective) bearing surface.

Tapered planforms and edge profiles could be adopted for such re-entrant forms.

### Multi-Element Detent

Rather than a unitary structure, a detent could comprise co-operatively disposed—possibly mutually inter-fitting—subsidiary detent elements.

Thus, an individual detent could be substituted by multiple discrete detent elements—set in a cluster or group for individual or collective movement.

Such detent split or fragmentation allows greater subtlety of control upon insertion or removal.

### Phased Location

Thus, detent portions could undergo relatively phased movement—i.e. location or insertion and removal—in relation to post apertures.

### Longitudinal Split

A longitudinally split or fragmented detent could employ successive intercoupled detent portions, say of progressively lesser width and/or depth in the direction of driving insertion.

In such a split detent a wider portion could locate initially within aligned aperture portions to one side of respective telescopic post sections.

This would be followed by a narrower detent portion engaging corresponding aperture portions at the opposite side.

### Lateral Split

Similar considerations could apply to a lateral split detent—say with detent portions juxtaposed side by side of similar or different operating length or span.

### Stacked Detent

Detents could be juxtaposed (mutually aligned or staggered), say, face-to-face in a vertical or horizontal stack.

Successive detents could have differential span, such as progressively greater span.

Thus (relative) displacement of each detent in turn effects incremental collective overall displacement.

Relatively slim individual detent layers or wafers could contribute to a substantial overall stack depth.

### Single—Multiple Contact Surfaces

Single or multiple contact surfaces may be employed at one or more sides.

### Single—Multiple—Offset—Inclined Contact Planes

A simple format is a single contact (flat) plane such as of FIG. 1, but multiple offset and/or relatively inclined planes may be employed.

A flat plane is convenient, but complex surface profiles are feasible.

These could be contrived to inhibit inadvertent detent dislodgement, even without a retention fastener.

Authorised detent removal would require knowledge of concealed geometry and prescribed movement sequence to extricate—and even then possibly only when posts are unloaded.

Thus, say, curved, and multiple contiguous segmented, say serrated, profiles may be adopted.

In this context, curve means shallow curved—as opposed to the markedly round or abrupt transitional forms of conventional round pin detents/apertures.

An objective remains to increase overall load bearing contact surface area.

A curve could provide a somewhat greater surface area in a given span.

A complementary aperture profile is employed for that portion of a detent in local contact—to allow insertion, removal and for load transfer.

### Combination

A combination of round pin and flat plate detent could be employed.

### Differential

Differential aperture and detent sections may be adopted to create some relative positional interaction, upon insertion and withdrawal.

### Symmetrical/Asymmetrical

Either or both symmetrical and asymmetrical detent forms, locally or overall, can be employed.

### Abrupt Transitional Profile

An abrupt transitional detent profile can help resist inadvertent dislodgement, without unduly obstructing insertion when unloaded.

### Multiple

Multiple, co-operatively disposed, mutually entrained, detents could be configured for simultaneous insertion or removal and mutual load sharing.

### Grouped

Thus grouped, say, paired detents upon a common transverse handle could be contemplated.

### Bifurcated

A bifurcated, split or multiple-limbed detent could be configured, with spaced ‘nose’ limbs at one (leading) end joined by a bridge at one (trailing) end.

### Stacked

Vertically and/or horizontally stacked detents, with attendant location apertures could be employed.

### Chamfer

Chamfer edged detent surfaces could map a surface transition, preserve some resistance to inadvertent withdrawal, yet facilitate insertion and removal.

Such a chamfer could be curvilinear—say ‘S’ profile—to soften an otherwise abrupt step transition.

### Lateral Re-Disposition

Detent profile could promote transverse or lateral relative post re-disposition, to take up mutual interfit slack or tolerance.

Thus, for example, an inner post could be urged towards an outer post at one side.

FIGS. 10A through 11C reflect a fuller overall picture of flat faced detents in operation with telescopic adjustable support posts of a collapsible platform base container or flat-rack, with diagonal inter-post bracing.

### Transverse Racking

In the construction of FIGS. 10A through 11C, transverse racking of the end-most opposed pair of corner post 70 base elements is countered by a movable cross-bracing gate 71.

However, there is no direct bracing of extendible upper (inner) post elements 72, when deployed well above the corresponding outer base post elements 70, as in FIGS. 10A and 11A.

Thus individual post extensions 72 are free to rack—unless a detent 73 is in situ between extension 72 and associated base elements 70.

Captive or entrained detents 70 could be employed in FIG. 10B, to inhibit complete withdrawal of a detent 73 from a detent aperture 74 in an outer base post element 70.

However, this obscures the sightline for an operator seeking to re-align detent apertures 75 of inner upper post element 72 after relative post element re-positioning.

To counter this, a supplementary modest viewing window 76 is provided over the detent aperture 74 proper—and which has minimal weakening effect upon the overall local post cross-section.

FIG. 11B depicts alignment resolution by modest greater local exposure of upper inner extensible post element 72 from a sight line just above a detent aperture 74 in outer base post element 70.

Pre-insertion of detent 73 in a detent aperture 74 in the outer base post element 70 relieves the amount of detent travel for full insertion between inner 72 and outer 70 post elements.

FIG. 11C depicts alternative detent 73 profile options, from single continuous taper to stepped incremental with intervening taper.

### Mix & Match

Features set out herein may be selectively mixed and matched to meet particular requirements—albeit it is not feasible to describe every possible combination or permutation.

### Component List

10 support post
11 inner post
12 outer post
13 capture fitting
14 slot (outer)
15 slot (inner)
20 detent
21A upper bearing surface
21B lower bearing surface
22 side
30 tapered planform detent
31 upper/lower face
32 side
33 detent nose apex
34 capture aperture
35 lock pin
36 head
37 retention (clip) fastener
38 lower retention stub
39 tolerance
43 outer exit aperture
44 outer entry aperture
45 inner exit aperture
46 inner entry aperture
50 inclined detent
51 upper/lower face
52 side
53 neck
54 locating head
64 ‘T’ profile slot
70 corner post (outer)
71 cross-bracing gate
72 inner post
73 detent
74 outer post aperture
75 inner post aperture
76 viewing window

1. A detent assembly, comprising: two relatively movable elements with openings which are aligned with each other when the elements are in a predetermined position, and a detent body inserted into the aligned openings to hold the two elements in the predetermined position with a (continuous or discontinuous) flat face bearing surface of the body in load supporting engagement with one of the two elements over substantially the entire surface area of a flat abutment face along one edge of the opening in the element.

2. The detent assembly of claim 1 wherein the detent body includes a second (continuous or discontinuous) flat face bearing surface in load supporting engagement with the other of the two elements over substantially the entire surface area of an abutment face along one edge of the opening in the other element.

3. The detent assembly of claim 1 wherein the detent body is tapered (in profile) in a direction generally perpendicular to the flat face bearing surface for wedge locking abutment with the surfaces defining the side edges of the openings in the two elements.

4. The detent assembly of claim 1 wherein the detent body is tapered in thickness (or depth) between the flat face bearing surface and an opposing surface, with at least one of the surfaces being inclined relative to the direction in which the body is inserted into the openings.

5. The detent assembly of claim 4 wherein the detent body is also tapered in width (or planform).

6. The detent assembly of claim 1 wherein the detent body has a generally trapezoidal profile with inclined side edges for interfitting engagement with corresponding edges at the sides of the openings.

7. The detent assembly of claim 1 wherein the detent body is one of a plurality of like (or mutually complementary form) bodies stacked together.

8. The detent assembly of claim 7 wherein the detent bodies are stacked together vertically (for cumulative depth).

9. The detent assembly of claim 7 wherein the detent bodies are stacked together in a side-by-side manner (for cumulative width).

10. The detent assembly of claim 7 wherein the detent bodies are movable relative to each other.

11. The detent assembly of claim 10 wherein the detent bodies all have similar (or mutually complementary) profiles.

12. The detent assembly of claim 10 wherein (some or all) the detent bodies have different profiles.

13. The detent assembly of claim 1 including a step adjacent to the flat bearing surface which abuts against one of the elements and prevents the detent body from being dislodged from the openings.

14. A detent assembly, comprising: a post of adjustable length having first and second post elements which are movable axially of each other between a plurality of predetermined indexed positions and have openings that are aligned with each other when the elements are in the predetermined positions, and a detent body of substantially rectangular cross-section which is inserted into the aligned openings to hold the two post elements in one of the predetermined positions with a (continuous or discontinuous) flat face bearing surface of the body in load supporting engagement with one of the post elements over substantially the entire surface area of a flat abutment face along one edge of the opening in the element.

15. The detent assembly of claim 14 wherein the openings in the post elements and the detent body are tapered and decrease in lateral dimension in the direction in which the body is inserted into the openings.

16. The detent assembly of claim 14 wherein the post elements are hollow, and the openings are formed in opposing side walls of the post elements.

17. The detent assembly of claim 16 wherein the openings and the detent body are of similar (or complementary) profile.

18. The detent assembly of claim 14 wherein the post is mounted in a fixed position on a base.

19. The detent assembly of claim 14 wherein the detent body has opposing flat face bearing surfaces for engagement with both of the post elements over substantially the entire surface areas of abutment faces along opposing edges of the openings to support both loads which stacked on the post and loads which are suspended from the post.

20. The detent assembly of claim 14 wherein the flat face bearing surface has a lateral extent which is a substantial portion of the lateral dimension of the post elements.

21. The detent assembly of claim 14 including a retaining element extending in a direction generally perpendicular to the flat face bearing surface for keeping the detent body in the openings.

22. A detent assembly, comprising: a post of adjustable length (or span) having first and second post elements which are movable axially of each other between a plurality of predetermined indexed positions and have openings that are aligned with each other when the elements are in the predetermined positions, and a detent body which is inserted into the aligned openings to hold the two post elements in one of the predetermined positions with a (continuous or discontinuous) bearing surface of the body in load supporting engagement with one of the post elements over substantially the entire surface area of an abutment face along one edge of the opening in the element.

23. The detent assembly of claim 22 wherein the openings are substantially coextensive in lateral dimension with the post elements.

24. The detent assembly of claim 22 wherein the bearing surface and the abutment face have a shallow curvature.

25. The detent assembly of claim 22 wherein the bearing surface is serrated (or discontinuous).

26. The detent assembly of claim 22 the detent body has a stepped (discontinuous) profile.

27. The detent assembly of claim 22 wherein the second post element is slidably mounted within the first post element, and the detent body has a profile such that insertion of the body into the openings forces portions of the second post element into contact with the first post section.

28. A detent assembly of claim 1 with a discontinuous flat face comprising a series of coplanar lands with intervening grooves or recesses.

29. A detent assembly of claim 28 with grooves or recesses aligned to lie parallel to a detent freedom of movement axis.

30. A detent assembly of claim 28 in which the opening edges are serrated or discontinuous with edge lands and intervening notches, corresponding to a discontinuous detent surface profile.

31. A detent assembly of claim 1 with locally enlarged opening edge profile to create viewing window through which to assess alignment of openings in respective members to preface detent insertion.
